(19) United States
(12) Patent Application Publication
(10) Pub. No.: US 2011/0216153 A1
(43) Pub. Date: Sep. 8, 2011

(54) DIGITAL CONFERENCING FOR MOBILE DEVICES

(76) Inventor: Michael Edric Tasker, Pleasanton, CA (US)

(21) Appl. No.: 12/716,913

(22) Filed: Mar. 3, 2010

(51) Int. Cl. H04N 7/15

(52) U.S. Cl. 348/14.02; 348/E07.083

(57) ABSTRACT

The present embodiments may relate to video conferencing. A conferencing gateway receives a video signal from one or more conferencing devices that are participating in a video conference. The video signal is adjusted to conform to the one or more mobile conferencing device specifications, such as display size, resolution, frame rate, or bandwidth. The adjusted video signal is transmitted to a mobile conferencing device for display.

### FIELD

The present embodiments relate generally to digital conferences, such as video conferences, audio conferences, or both video and audio conferences.

### BACKGROUND

A digital conference may be a conference that allows two or more conferencing devices to interact via two-way video and/or audio transmissions. Digital conferencing uses telecommunications of audio and/or video to bring people at different sites together for a meeting. This may include a conversation between two people in private offices (e.g., point-to-point) or involve several sites (e.g., multi-point) with more than one person in large rooms at different sites. Besides the audio and visual transmission of meeting activities, videoconferencing can be used to share documents, computer-displayed information, and whiteboards.

### BRIEF DESCRIPTION OF THE DRAWINGS

FIG. 1 illustrates one embodiment of a digital conferencing system;

FIG. 2 illustrates one embodiment of a conference image;

FIG. 3 illustrates one embodiment of a conferencing system;

FIG. 4 illustrates one embodiment of a conference device that includes a triangulation system;

FIG. 5 illustrates one embodiment of a conferencing system;

FIG. 6 illustrates one embodiment of a conference device used to select a conference image;

FIG. 7 illustrates another embodiment of a conference device used to select a conference image; and

FIG. 8 illustrates one embodiment of a method for adjusting a conference image.

### DESCRIPTION

### Overview

The present embodiments relate to digital conferences. Digital conferences may include video conferences, audio conferences, or both video and audio conferences. However, other technology may be included in the digital conferences, such as document sharing, computer-displayed information, and whiteboards. The present embodiments relate to video conferences in which a mobile device is used as a video conferencing system. The mobile device may be, for example, a small screen mobile device, such as a cellular telephone, smart phone, personal digital assistant, book reader, or electronic tablet. In one embodiment, a video signal may be adjusted to correspond to a display device of the mobile device. The resolution, size, bandwidth, frame rate, and/or focus of the video signal may be adjusted. For example, the video signal may be adjusted to focus on and optimize the display of the face of the speaker that is presently speaking in the video conference. In another embodiment, a video signal may be selected and displayed based on conference participant input, the conference participant speaking or scheduled to speak, or a time interval.

Adjusting a video signal to correspond to a display device of a mobile device may be beneficial because video conference systems generally provide a full size (e.g., a “life size”) image on a screen appropriate for room based systems. For a conference participant using a video capable mobile device, rendering the full size image onto a small screen is not that useful. The present embodiments relate to adjusting the full size image to fit or correspond to a display device of the video capable mobile device. Adjusting the full size image may include adjusting the size (e.g., shrinking) of the full size image, adjusting the resolution, and/or focusing on one or more portions of full size image. Focusing may include cropping or clipping the full size image, which may involve removing the background of the full size image. The cropped image may focus on a video conference participant's face. For example, focus may be on the video conference participant that is speaking or is scheduled to speak, allowing the video conference participant using the video capable mobile device to view a close up image or video of the video conference participant speaking.

Selecting and displaying a video signal may be beneficial because the video conference may include multiple video conference participants and a video conference participant may want or need to scroll through close up images or video of the conference participants in the video conference.

In one aspect, a method may be performed by a conferencing gateway. The method includes receiving a video signal at a conferencing gateway, the video signal being received as input to one or more conferencing devices that are used to participate in a video conference, adjusting the video signal to conform to a mobile conferencing device specification to optimize viewing on a mobile conferencing device, and transmitting the adjusted conferencing signal to the mobile conferencing device for display on a display device of the mobile conferencing device.

In a second aspect, computer readable storage media may include logic that is executed by a processor to receive one or more video signals, the one or more video signals being output to one or more conferencing devices that are used to participate in a video conference, select a video signal based on a conference context, adjust the selected video signal to conform to a display device of a mobile conferencing device and the conference context, transmit the adjusted video signal to the mobile conferencing device for display on the display device of the mobile conferencing device, and transmit the one or more video signals to the one or more conferencing devices.

In a third aspect, a system includes a video conferencing device configured to generate a video signal, a conference gateway configured to receive the video signal and adjust the video signal to conform to a mobile conferencing device specification, and a mobile conferencing device configured to receive the adjusted video signal from the conference gateway and present the adjusted video signal on a display.

### DETAILED DESCRIPTION

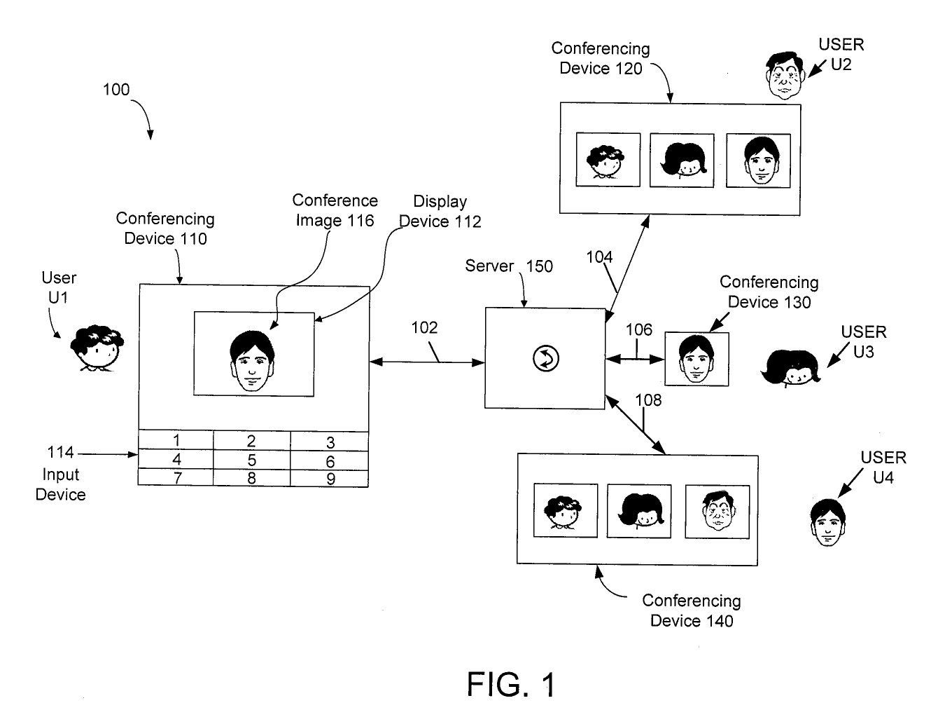

FIG. 1 illustrates a digital conference system 100. The system 100 may include one or more conferencing devices 110, 120, 130, 140 and a server 150. Conferencing device 110 may be coupled with the server 150 via network 102, conferencing device 120 may be coupled with the server 150 via network 104, conferencing device 130 may be coupled with the server 150 via network 106, and conferencing device 140 may be coupled with the server 150 via network 108. As used herein, the term “coupled with” includes directly connected or indirectly connected through one or more intermediary components. Intermediary components may include hardware, software, or network components. For example, conferencing device 110 may be connected to the server 150 via one or more intermediary components, such as cellular networks or servers. The system 100 may include additional, different, or fewer components.

The networks 102-106 may be telecommunication networks, digital networks, wireless networks, wired networks, radio networks, Internet networks, intranet networks, Transmission Control Protocol (TCP)/Internet Protocol (IP) networks, Ethernet networks, packet-based networks, fiber optic network, telephone network, cellular networks, computer networks, public switched telephone networks, or any other now known or later developed networks. Example telecommunication networks may include wide area networks, local area networks, virtual private networks, peer-to-peer networks, and wireless local area networks. The networks 102-106 may be operable to transmit messages, communication, information, or other data to and/or from the server 150.

The conferencing devices 110-140 may be owned, operated, managed, controlled, viewed, programmed, or otherwise used by one or more users. For example, in one embodiment, as shown in FIG. 1, conferencing device 110 may be used by User U1, conferencing device 120 may be used by User U2, conferencing device 130 may be used by User U3, and conferencing device 140 may be may be used by User U4. In an alternative embodiment, User U3 may use both conferencing device 130 and conferencing device 140. Users U1-U4 may be humans or electrical devices (e.g., including a processor and/or memory) configured or programmed to use the conferencing devices 110-140.

The conferencing devices 110-140 may be public switched telephones, cellular telephones, personal computers, personal digital assistants, mobile devices, electronic tablets, remote conferencing systems, small-screen devices, large-screen devices, video conferencing systems, or other devices that are operable to participate in video conferences.

For example, in one embodiment, the conferencing device 110 may be a video-enabled cellular telephone, such as an iPhone® sold by Apple, Inc. or an HTC Fuze® sold by HTC, Inc. The video-enabled cellular telephone may be operable to stream video from the server 150. The video-enabled cellular telephone may include a video camera 116, which may or may not be used during a video conference.

In an example embodiment, the conferencing device 120 may be a telepresence system, such as the Cisco TelePresence System 3000 sold by Cisco, Inc. The Cisco TelePresence System 3000 is an endpoint for group meetings, creating an environment for multiple people to meet in one location, and to be “virtually” joined by additional people. In one embodiment, the Cisco TelePresence System 3000 integrates three 65-inch plasma screens and a specially designed table that seats six participants on one side of the “virtual table.” The Cisco TelePresence System 3000 may support life-size images with ultra-high-definition video and spatial audio. A multipoint meeting can support many locations on a single call. The Cisco TelePresence System 3000 may include one or more cameras, a lighting array, microphones, and speakers. Cisco TelePresence System 3000 allows participants to see and hear each conference participant.

The conferencing devices 110-140 may include a display device 112, an input device 114, and a video camera 116. Additional, different, or fewer components may be provided. For example, in one embodiment, the video camera 116 is not provided or just not used. As discussed below, the conferencing device 110 may be a cellular telephone that includes a video camera 116 but because the video camera 116 is located on the opposite side of the telephone as display device 112, video camera 116 may or may not be used during a video conference. In another embodiment, a wireless communication system may be provided. The wireless communication system may be operable to communicate via a wireless network.

The display device 112 may be a cathode ray tube (CRT), monitor, flat panel, touch screen, a general display, liquid crystal display (LCD), projector, printer or other now known or later developed display device for outputting information. The display device 112 may be operable to display one or more images, text, video, graphic, or data. Additional, different, or fewer components may be provided. For example, multiple displays and/or speakers may be provided.

As shown in FIG. 1, the display device 112 may be operable to display a conference image 118. A conference image 118 may include still images or representations, animated images or representations, video signals, text, graphics, or other data representing a user. For example, the conferencing system 120 may record a video signal of user U2 and transmit the video signal to the server 150. The server 150 may provide the video signal to the conferencing system 110. The video signal may be displayed on the display device 112. In this example, the video signal is the conference image 118. In an example embodiment, the conferencing device 110 may not include a video camera 116, so the conference image 118 may be, for example, a synthetic animated cartoon or avatar image to represent the remote user. The image may be animated by speech detection software that is capable of identifying large structures in the audio such as vowels and plosives and fricatives to animate the mouth of the avatar to mimic lip sync.

The display device 112 may be a small screen or a large screen. A small screen may be sized to display only one or only a few (e.g., 2, 3, or 4) conference images 116. For example, the display device 112 of the conferencing system 110 may be a small screen display device. In contrast to the display device of the conferencing system 120, which may be a projection screen sized to display a plurality of images, the display device 112 may only be large enough to display a single conference image 116. For example, the small screen display device 112 may only be large enough to display a video signal from a single user. A large screen may have one or more display devices that are sized to display a plurality of conference images. For example, the conferencing device 120 may be sized to display a conference image 116 of all or some of users participating in the video conference, for example, User U1, U3, U4. A small screen may be able to display multiple images or a single image combined from multiple cameras. However, the size may result in undesired resolution or detail being shown for an image or images displayed at a same time on the small screen.

Example sizes of small screen display devices may include approximately 0.5-24 inches. In one embodiment, the size of a small screen display device is less than 8 inches. Example sizes of large screen display devices may include approximately 12 inches to 8 feet. In one embodiment, the size of a large screen display device is 60 inches.

The input device 114 may be a user input, network interface, external storage, other device for providing data to the server 150, or a combination thereof. Example user inputs include mouse devices, keyboards, track balls, touch screens, joysticks, touch pads, buttons, knobs, sliders, combinations thereof, or other now known or later developed user input devices. The user input may operate as part of a user interface. For example, one or more buttons may be displayed on a display. The user input is used to control a pointer for selection and activation of the functions associated with the buttons. The input device 114 may be a hard-wired or wireless network interface. For example, the input device 114 may be coupled with the networks 102-108 to receive data from one or more communication devices. For example, the conferencing devices 110-140 may be controlled from a remote location. A universal asynchronous receiver/transmitter (UART), a parallel digital interface, a software interface, Ethernet, or any combination of known or later developed software and hardware interfaces may be used. The network interface may be linked to various types of networks, including a local area network (LAN), a wide area network (WAN), an intranet, a virtual private network (VPN), and the Internet. The input device 114 may include a telephone keypad. The telephone keypad may include keys that produce dual-tone multi-frequency (DTMF) tones and may be referred to as “DTMF keys.” For example, DTMF keys 2, 4, 6, and 8 may be used as arrows for providing input.

The server 150 may be a DSP/video gateway, central server, telepresence server, Web server, video conferencing server, secure server, internal server, conferencing server, personal computer, or other device or system operable to support a video conference. The server 150 may be configured or programmed to support a video conferencing. Video conferencing uses telecommunications of audio and video to bring the Users U1-U4, which may be at the same or different sites, together for a meeting. Video conferencing may include a conversation between two people in private offices (point-to-point) or involve several sites (multi-point) with more than one person in large rooms at different sites. Besides the audio and visual transmission of meeting activities, videoconferencing can be used to share documents, computer-displayed information, and whiteboards. More than one server 150 may be used for a given video conference.

Supporting a video conference may include establishing, setting up, joining, and/or maintaining connection to a video conference connection. As shown in FIG. 1, the server 150 may support a video conference between Users U1-U4 using the conferencing device 110-140. The server 150 may connect the conferencing device 110-140 and allow the Users U1-U4 to use the conferencing devices 110-140 during the video conference to view conference images 116 of all, some, only one, or none of the users U1-U4.

The server 150 may receive one or more conferencing signals from the conferencing devices 110-140. A conferencing signal may include an audio signal and a video signal. Alternately, the video signal may include audio. The video signal may include one or more conference images 116. For example, the server 150 may receive a conference image 116 of User U1 from the conferencing device 110; a conference image 116 of User U2 from the conferencing device 120; a conference image 116 of User U3 from the conferencing device 130; and a conference image 116 of User U4 from the conferencing device 140.

The server 150 may transmit one or more conference signals conference images 116 to the conferencing devices 110-140. For example, the server 150 may transmit a conference image 116 of User U2, U3, and/or U4 to the conferencing device 110. The conference images may be transmitted at the same or different times.

The server 150 may generate an adjusted conferencing signal that conforms to a specification of the conferencing device. A specification may include a requirement, capability, preference, setting, or other specification that optimizes viewing. The adjusted conferencing signal may include an adjusted conference image 116. The resolution, size, or focus of the conferencing signal, or any combination thereof may be adjusted. For example, in one embodiment, the conferencing system 120 may adjust the resolution of a video signal. In this example, the conferencing device 120 may record a video signal with a resolution of 1080 p and transmit the video signal to the server 150. Prior to sending the video signal to the conferencing system 110, which may be mobile device with a low-resolution display device 112, the server 150 may adjust the resolution of the video signal to correspond to the display device 112. A low-resolution display device may have a resolution of 720 p, 480 by 320 pixels or 800 by 480 pixels. Video signals with such low-resolutions may be transmitted at a lower bandwidth than video signals with a higher resolution (e.g. 1080 p). Accordingly, the server 150 may adjust the resolution of the video signal to lower the bandwidth of the video signal. In other words, the sever 150 may adjust the video signal to include the optimum or acceptable video for a particular display device or mobile device.

In another implementation, the server 150 may adjust a display size. As used herein, the “display size” relates to the size that the video signal is displayed on a viewing device, such as a display device 112. Adjusting the display size may include shrinking or enlarging. For example, the conferencing system 120 may record a video signal that is to be viewed on a large screen conferencing system, such as a projection screen (e.g., approximately 60+ inches). The video signal may be transmitted to the server 150. The server 150 may recognize that the display device 112 of the conferencing device 110 includes a small screen (e.g., approximately 3 inches). The server 150 may adjust the display size of the video signal to fit on the small screen. For example, surrounding regions for a life size image are clipped so that the image may be displayed smaller than life size with desired resolution. Adjusting the display size may also include adjusting resolution or focus, in order to avoid rending the video signal unclear or fuzzy. Adjusting the display size also reduces the required bandwidth for the video signal.

In another implementation, the server 150 may adjust the frame rate of the video signal to correspond to the capabilities of display device 112 of the mobile device. A frame rate of the display device may be anywhere from 1 frame per second to 80 FPS. Frame rates suitable for broadcast quality video (e.g. 60 FPS) can be achieved by mobile devices. However, lower frame rates (e.g. 10 FPS) require less bandwidth. Accordingly, the server 150 may adjust the frame rate of the video signal to lower the bandwidth of the video signal.

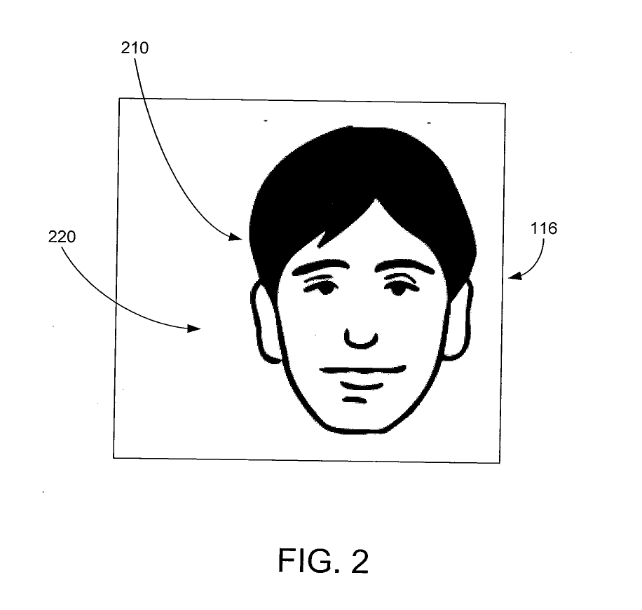

In yet another embodiment, the server 150 may adjust the display focus. Adjusting the display focus may include focusing or cropping around, for example, a face of a conference participant (e.g., User U1-U4). For example, in one embodiment, as shown in FIG. 2, the server 150 may receive a conference image 116 from conferencing device 140. The conference image 116 may include a video 210 of the user U4. The server 150 may use face recognition or face detection mechanisms, tools, processes, hardware, software, or a combination thereof to optimize focus and exposure of the face of user U4. As a result, the face of user U4 may be clearly visible. Face recognition may include recognizing that the conference image includes one or more faces, and to use that to bias the focus and exposure of the conference image 116. Biasing the focus may include cropping the display size of the conference image to a size that optimizes exposure to user U4. This may include ensuring that all, some, or none of the face of user U4 is displayed on the display device 112. As shown in FIG. 2, the cropped conference image 220 may be transmitted to the conferencing device 110 for display on the display device 112. Focus includes optical focus, zooming in, zooming out, and/or clipping.

The server 150 may be operable to select a conference image 118 based on conferencing context. Conferencing context may include speaker information, a time interval, user input, or other data about the video conference.

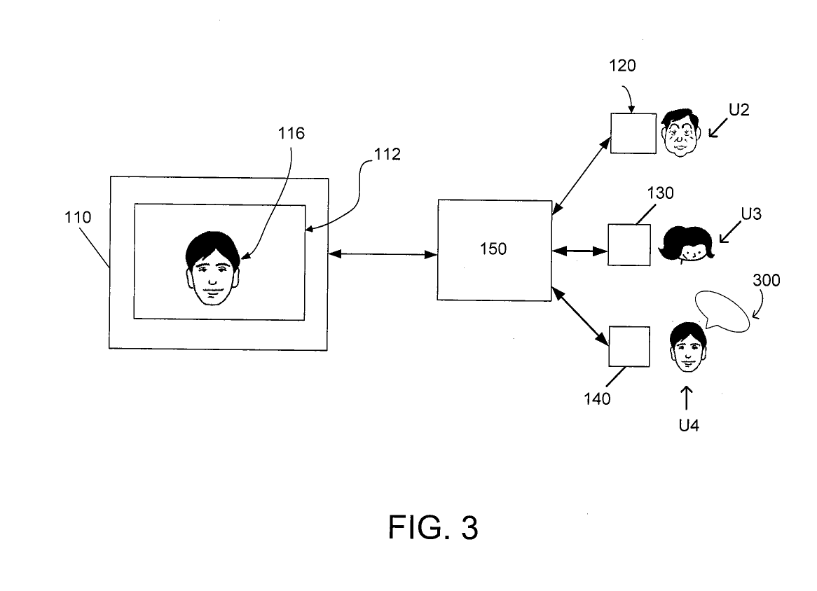

For example, in one embodiment, as shown in FIG. 3, the server 150 may select a conference signal based on speaker information. Speaker information may define the current speaker. Speaker information may be used to distinguish between the current speaker and non-speakers. As shown in FIG. 3, user U4 may be speaking 300. The server 150 may detect that user U4 is speaking 300, for example, using speech recognition software, triangulation system, or other system capable of distinguishing between conference participants. For example, when users U2-U4 are using different conferencing devices 120-140, as shown in FIG. 3, the server 150 may distinguish based on reception of the audio signals.

In response to recognizing that user U4 is speaking, the server 150 may transmit the conference signal from conferencing device 140 to the conferencing device 110, the conferencing device 120, the conferencing device 130, or a combination thereof. In the event that user U3 was speaking prior to user U4, the server 150 may stop or cease transmitting the conference signal from user U3 in response to detection of user U4 speaking 300. In one embodiment, both the conference signal from user U3 and U4 may be transmitted, for example, when user U3 and U4 are speaking simultaneously.

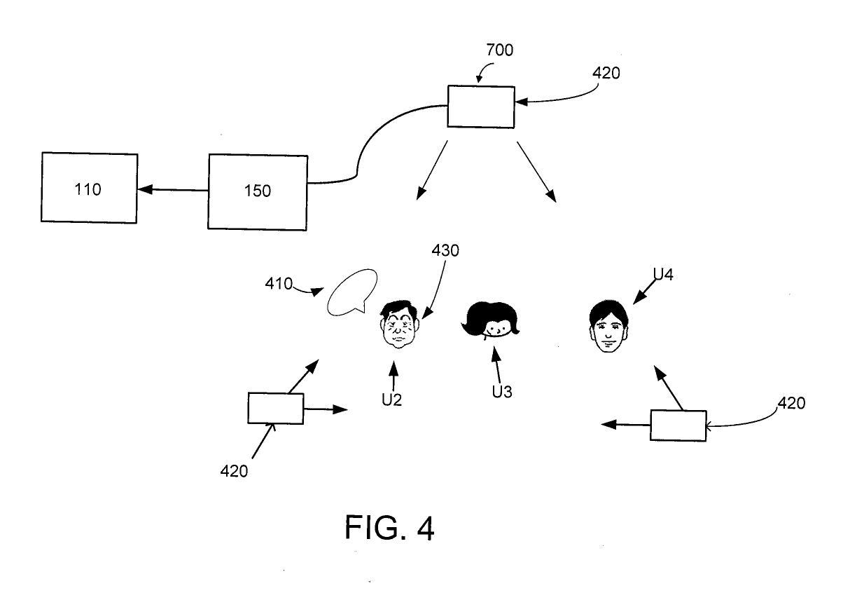

Alternatively, or additionally, a conferencing device 110-140 may determine speaker information and detect which user is speaking. For example, as shown in FIG. 4, users U2-U4 are using the same conferencing device 400. The conferencing device 700 and/or server 150 may use speech recognition software to distinguish between users U2-U4. The speech recognition software may use tone, pitch, volume, or motion of mouths to detect which user is speaking. In an alternative embodiment, as shown in FIG. 4, the conferencing device 700 may include a triangulation system that is configured to determine which user U2-U4 is speaking 410, which is user U2. The triangulation system may include three or more measuring devices 420, such as cameras, microphones, infrared transceiver, ultrasonic transceiver, sensor bar, array of sensors, positioning system, or other now known or later developed device for measuring a distance or determining a location. The measuring devices 420 may be used in combination with one and another to determine which speaker is speaking 410. For example, the triangulation system may determine a location of the speaker using triangulation and then associate the location with a user. For example, user U1 may be associated with location 430. Triangulation is the process of determining the location of a point by measuring angles to the location from known points at either end of a fixed baseline, rather than measuring distances to the point directly. The point can then be fixed as the third point of a triangle with one known side and two known angles.

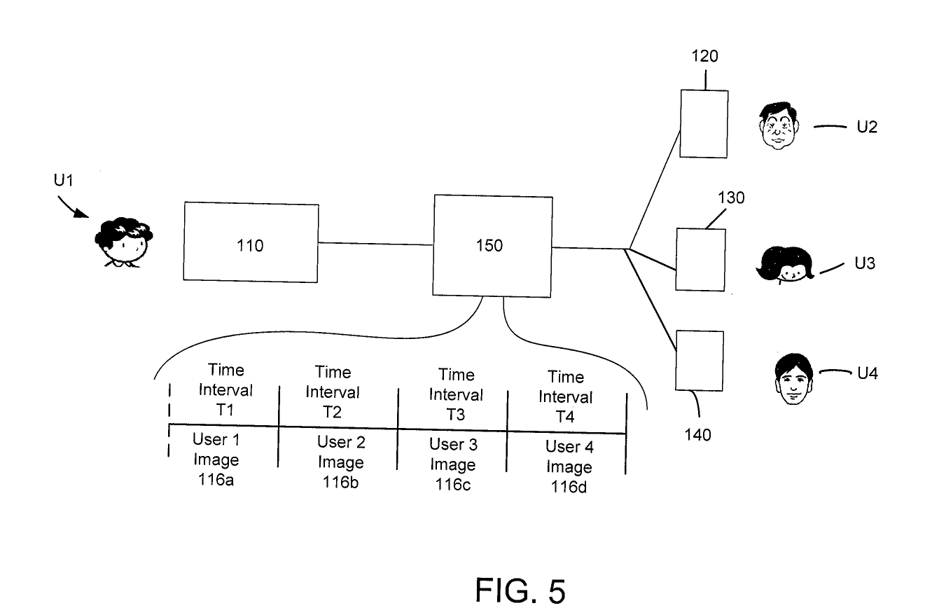

As shown in FIG. 5, the server 150 may select a user based on a time interval. A time interval may be associated with one or more users. For example, in one embodiment, the conferencing device 110 and/or server 150 may cycle through time intervals. During time interval T1, a conference image 116 of user U1 may be displayed on display device 12. During time interval T2, a conference image 116 of user U1 may be displayed on display device 12. During time interval T3, a conference image 116 of user U3 may be displayed on display device 12. During time interval T4, a conference image 116 of user U4 may be displayed on display device 12. Additional or less time intervals may be used. For example, time interval T1 may not be present for conferencing device 110, since the user U1 does not need to see a video of user U1. However, in an alternative embodiment, user U1 may view a video of user U1.

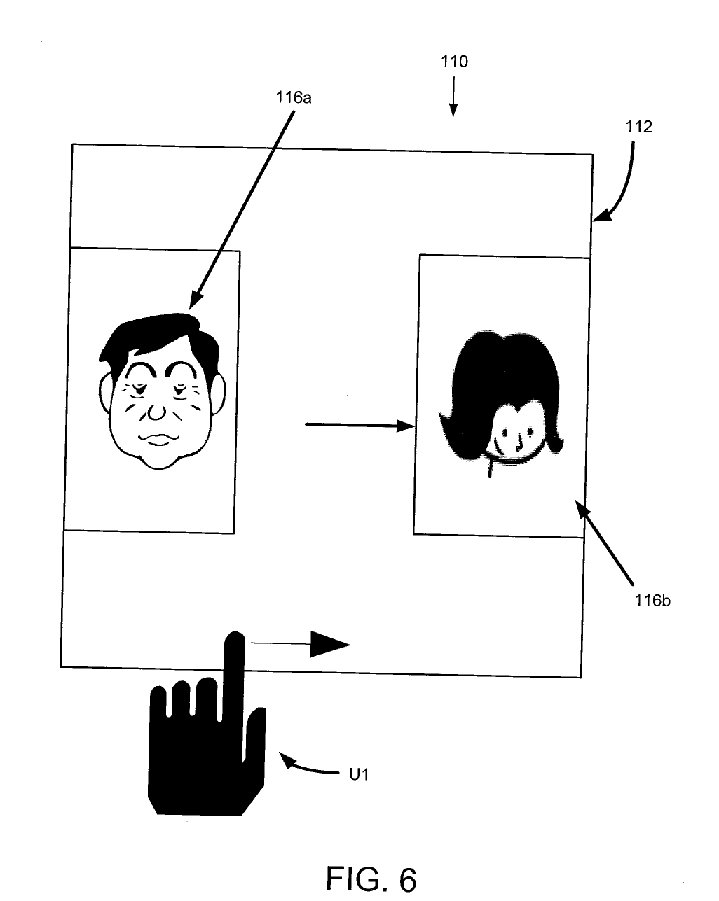

As shown in FIG. 6, user input may be used to select a conference image 116 to be displayed. The server 150 may generate one or more video signals for each user U1-U4. For example, as shown in FIG. 6, the server 150 may generate a conference image 116a for user U2 and a conference image 116b for user U3. The conferencing device 110 may be a mobile device with a touch screen as the display device 112. The user U1 may slide between conference images 116a, 116b. For example, a conference image 116b of user U3 may be displayed on the display device 112. In response to hearing that user U2 has begun to speak, user U1 may slide his finger across the touch screen, the conference image 116a of user U2 may slide into the display device 112 as the finger is slid across the touch screen.

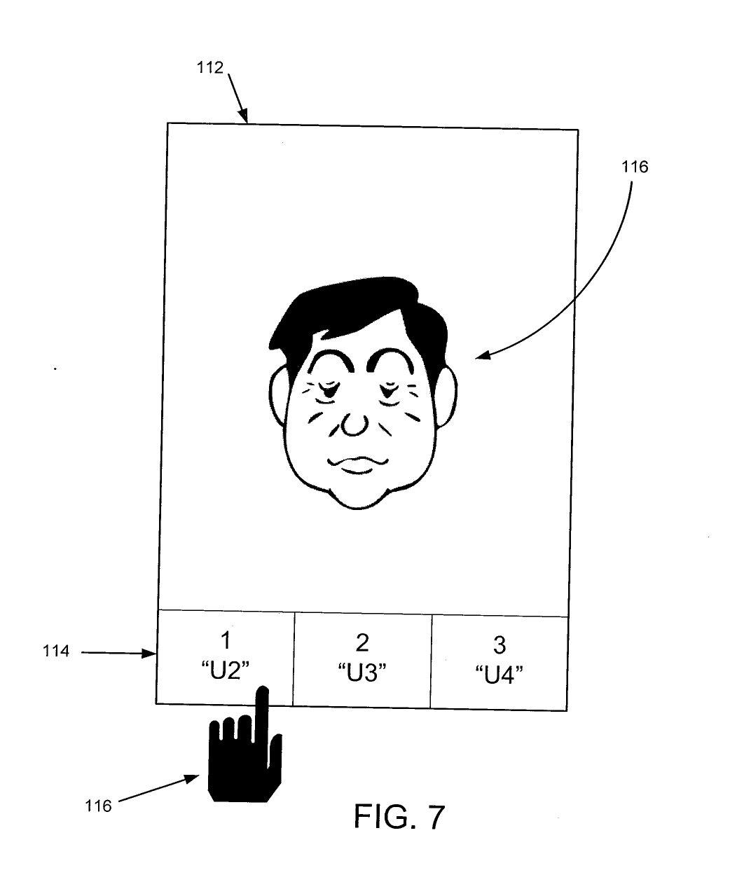

FIG. 7 shows another example of selecting a conference image 116 to be displayed based on user input. The user U1 may use the input device 114, which may be a keypad. One or more keys on the keypad may be associated with one or more users U2-U4. For example, pressing key 1 may display a conference image 116 of user U2. Pressing key 2 may display a conference image 116 of user U2. Pressing key 3 may display a conference image 116 of user U2. The user U1 may press the various keys with one or more fingers. Other input may be used to select a conference image 116.

The server 150 may transmit the adjusted conferencing signal to the mobile conferencing device for display on a display device of the mobile conferencing device. For example, the server 150 may transmit the adjusted conferencing signal using a protocol, such as the session initiation protocol (SIP), H.323, or a web based protocol such as HTTP/HTML and/or RTSP or some other rich-media protocol. In alternative embodiments, the mobile conference device receives the conferencing signals and adjusts at the mobile conference device.

The server 150 may include a processor and memory. Additional, different, or fewer components may be provided. The processor may be coupled with the memory. Although the server 150 is referred to herein as a server, the server 150 may be a personal computer, gateway, router, mobile device, or other networking device. In an alternative embodiment, one, some, or all of the acts performed by the server 150 may be performed on or in a conferencing device or intermediary component.

The processor may be a general processor, digital signal processor, application specific integrated circuit, field programmable gate array, analog circuit, digital circuit, combinations thereof, or other now known or later developed processors. The processor may be single device or a combination of devices, such as associated with a network or distributed processing. Any of various processing strategies may be used, such as multi-processing, multi-tasking, parallel processing, or the like. Processing may be local, as opposed to remote. In an alternative embodiment, processing may be performed remotely. Processing may be moved from one processor to another processor. The processor may be responsive to logic encoded in tangible media. The logic may be stored as part of software, hardware, integrated circuits, firmware, micro-code or the like.

The memory may be computer readable storage media. The computer readable storage media may include various types of volatile and non-volatile storage media, including but not limited to random access memory, read-only memory, programmable read-only memory, electrically programmable read-only memory, electrically erasable read-only memory, flash memory, magnetic tape or disk, optical media and the like. The memory may be a single device or combinations of devices. The memory may be adjacent to, part of, programmed with, networked with and/or remote from processor.

The processor may be operable to execute logic encoded in one or more tangible media, such as memory. Logic encoded in one or more tangible media for execution may be instructions that are executable by the processor and that are provided on the computer-readable storage media, memories, or a combination thereof. The processor is programmed with and executes the logic. The functions, acts or tasks illustrated in the figures or described herein are executed in response to one or more sets of logic or instructions stored in or on computer readable storage media. The functions, acts or tasks are independent of the particular type of instructions set, storage media, processor or processing strategy and may be performed by software, hardware, integrated circuits, firmware, micro code and the like, operating alone or in combination.

In one embodiment, the memory may be computer readable storage media and may include logic that is executed by the processor to receive one or more video signals, the one or more video signals being input to one or more conferencing devices that are used to participate in a video conference; select a video signal based on conference context; adjust the selected video signal to conform to a specification of a mobile conferencing device; and transmit the adjusted conferencing signal to the mobile conferencing device for display on a display device of the mobile conferencing device.

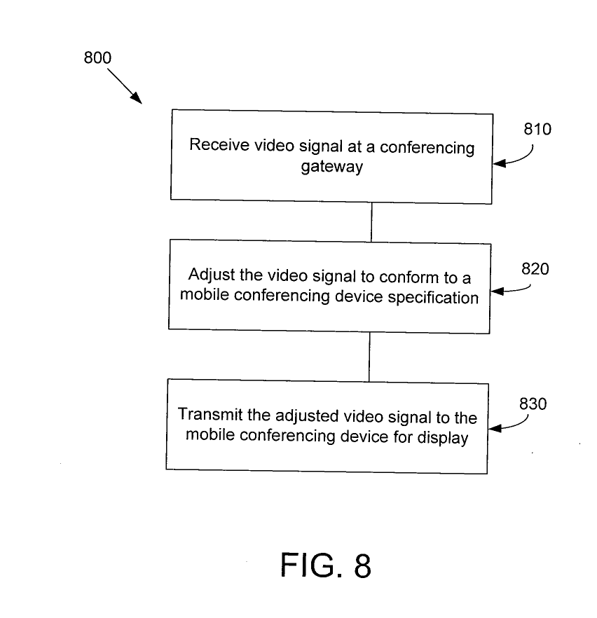

FIG. 8 illustrates one embodiment of a method 800 for providing a conferencing signal to a mobile device. The method includes using a processor to perform the following acts. The acts may be performed in the order shown or a different order. The processor may be part of, integrated in, used by, or in communication with a server.

In act 810, the server or conferencing gateway may receive one or more video signals. The one or more video signals may be input to one or more conferencing devices that are used to participate in a video conference. For example, the one or more conferencing devices may have video conferencing cameras and/or microphones to capture video signals and audio signals. The video and audio signals may be transmitted to the server. The video signal may be a high resolution signal or formatted to fit a large screen. The server optionally determines a conference context.

The conference context may include speaker information, a time interval, facial recognition, speaker information, user input, or a combination thereof. For example the server may determine which user is speaking based on facial recognition of the user speaking, based on a time interval when the user speaking is scheduled to speak, based on audio present in the video signal of the user speaking, or simply based on a user input. The user input could originate with either the user of the mobile conferencing device or the user speaking.

In act 820, the server may adjust the video signal to conform to a mobile conferencing device specification and/or based on the conference context. For example, the video signal may be adjusted to focus on a speakers face based on the display size of the mobile conferencing device. In another example, the video signal may be adjusted from a first resolution to a second resolution. In act 830, the adjusted video signal may be transmitted to the mobile conferencing device for display on a display device of the mobile conferencing device.

Various embodiments described herein can be used alone or in combination with one another. The foregoing detailed description has described only a few of the many possible embodiments. For this reason, this detailed description is intended by way of illustration, and not by way of limitation.

I (We) claim:

1. A method comprising:
receiving a video signal, at a conferencing gateway, from one or more conferencing devices participating in a video conference;
adjusting the video signal to conform to a mobile conferencing device specification to optimize viewing on a mobile conferencing device; and
transmitting the adjusted video signal to the mobile conferencing device for display on a display device of the mobile conferencing device.

2. The method of claim 1, wherein the input is received using a video conferencing camera.

3. The method of claim 2, wherein the mobile conferencing device specification is the size of the display device and the video signal is adjusted so that a displayed image conforms to a size of the display device of the mobile conferencing device.

4. The method of claim 3, wherein the mobile conferencing device specification is a resolution of the display device and adjusting the video signal includes adjusting a resolution of the video signal.

5. The method of claim 3, wherein adjusting the video signal includes cropping the video signal.

6. The method of claim 5, wherein cropping the video signal includes detecting a face of a video conference participant and focusing on the face of the video conference participant.

7. The method of claim 1, wherein the mobile conferencing device specification is a frame rate of the display device and adjusting the video signal includes adjusting a frame rate of the video signal.

8. The method of claim 7, wherein the small-screen mobile device includes the display device that has a screen size of 6 inches by 6 inches or less.

9. The method of claim 1, further comprising:
generating a conferencing signal including an audio signal of a conference participant and the video signal comprising an image representation of the conference participant.

10. The method of claim 1, wherein the video signal includes one or more conference participant signals used to display images of one or more conference participants.

11. Computer readable storage media including logic that is executed by a processor to:
receive one or more video signals for use in a video conference involving one or more conferencing devices;
select a video signal based on a conference context;
adjust the selected video signal to conform to a display device of a mobile conferencing device and the conference context;
transmit the adjusted video signal to the mobile conferencing device for display on the display device of the mobile conferencing device; and
transmit the one or more video signals to the one or more conferencing devices.

12. The computer readable storage media of claim 11, wherein the one or more video signals include audio.

13. The computer readable storage media of claim 12, wherein generating the adjusted conferencing signal includes adjusting the video signal to be displayed on the display device of the mobile conferencing device.

14. The computer readable storage media of claim 13, wherein adjusting the video signal includes adjusting the resolution of the video signal.

15. The computer readable storage media of claim 15, wherein adjusting the video signal includes cropping a size of the video signal and cropping includes detecting a face of a video conference participant and focusing on the face the video conference participant.

16. The computer readable storage media of claim 15, wherein the conference context identifies a current speaker.

17. A system comprising:
a video conferencing device configured to generate a video signal;
a conference gateway configured to receive the video signal and adjust the video signal to conform to a mobile conferencing device specification; and
a mobile conferencing device configured to receive the adjusted video signal from the conference gateway and present the adjusted video signal on a display.

18. The apparatus of claim 17, wherein the one or more specifications include a resolution of the display or a size of the display.

19. The apparatus of claim 17, wherein the conference gateway is further configured to detect a face of a conference participant.

20. The apparatus of claim 18, wherein the conference gateway adjusts the video signal by focusing on the face of the conference participant.
